(19) United States
(12) Patent Application Publication
(10) Pub. No.: US 2008/0307391 A1
(43) Pub. Date: Dec. 11, 2008

(54) Acquiring coverage data from a script

(75) Inventor: Rajeev Goel, Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/811,543

(22) Filed: Jun. 11, 2007

(51) Int. Cl. G06F 9/44

(52) U.S. Cl. 717/115

(57) ABSTRACT

Various technologies and techniques are disclosed for providing code coverage for scripts. A code coverage process is provided that measures the code coverage of a script while the script executes. An instrumenting process injects code into the script to track which lines were executed. The script is executed with the injected code that allows code coverage results to be gathered. The code coverage results are output so they can be further analyzed. A graphical tool that was only intended to display coverage data from compiled code can be enabled to also display coverage data from a script. A code coverage application is provided that was only designed to display coverage data gathered from executions of compiled code. The code coverage application can display coverage data from scripts by providing a script code coverage process that writes coverage data in a coverage data format understood by the code coverage application.

### BACKGROUND

Software developers write software programs in one or more languages using a software development tool. The software developer writes the software in the form of source code, which are the individual instructions that are later compiled into a program that can be executed on an end user computer. Complex software programs may end up consisting of millions of lines of source code. Various tools have evolved to enable software developers to analyze the execution of their programs under development to see how the programs can be improved. One example of such a tool is a debugger that allows the developer to step through the execution of a program one line of source code at a time. Another example of a tool increasingly being used by developers is a code coverage tool that measures which machine instructions the particular software program executed when it ran. The code coverage tool can then provide the user with coverage information, which is useful so the developer can see what portions of the particular program are being called and which ones are not. This information is also useful for a variety of other reasons. The problem with existing code coverage tools is that they only work with code that has been compiled into a binary format.

Scripts are often used in today's world of computer software development, and in some cases, are being used just as much as compiled programs. Scripts are interpreted on the fly by a runtime interpreter, without having to be compiled into a binary format. Scripts are easy to copy from one machine to another, to open in a text editor and read, and so on. One example of a script includes a web script that provides a browser based user interface, such as Java Script, VB Script, and others. Another example of a script that is sometimes used is called a build script. A build script is a program that is written in a scripting language for the purposes of describing how a particular software project should be built. Build scripts are often used by software development teams to customize how the particular software project should be built in their specific environment and/or in a customer's environment.

### SUMMARY

Various technologies and techniques are disclosed for providing code coverage for scripts. A code coverage process is provided that measures the code coverage of a script while the script executes. An instrumenting process injects code into the script to track which lines were executed. The script is executed with the injected code that allows code coverage results to be gathered. The code coverage results are output so they can be further analyzed.

In one implementation, a graphical tool that was only intended to display coverage data from compiled code can be enabled to also display coverage data from a script. A code coverage application is provided that was only designed to display coverage data gathered from executions of compiled code. The code coverage application can display coverage data from scripts by providing a script code coverage process that writes coverage data in a coverage data format understood by the code coverage application.

This Summary was provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a script code coverage application of one implementation operating on the computer system of FIG. 1.

FIG. 3 is a process flow diagram for one implementation of the system of FIG. 1 illustrating the stages involved in measuring code coverage for a script.

FIG. 4 is a process flow diagram for one implementation of the system of FIG. 1 illustrating the stages involved in using code coverage to diagnose defects in a script.

FIG. 5 is a process flow diagram for one implementation of the system of FIG. 1 illustrating the stages involved in using code coverage to measure/analyze test coverage of a production script.

FIG. 6 is a process flow diagram for one implementation of the system of FIG. 1 illustrating the stages involved in using code coverage to gather customer usage data of a production script.

FIG. 7 is a process flow diagram for one implementation of the system of FIG. 1 that illustrates the stages involved in graphically displaying coverage data for a script.

FIG. 8 is a simulated screen for one implementation of the system of FIG. 1 that illustrates displaying code coverage results for a script.

FIG. 9 is a process flow diagram for one implementation of the system of FIG. 1 that illustrates the stages involved in graphically displaying coverage data for a script in a system that was not designed to display code coverage for a script.

FIG. 10 is a simulated screen for one implementation of the system of FIG. 1 that illustrates a development environment that displays code coverage of a script.

FIG. 11 is a simulated screen for one implementation of the system of FIG. 1 that illustrates a user settings dialog of a development environment that allows coverage data display settings to be specified for a script.

FIG. 12 is a process flow diagram for one implementation of the system of FIG. 1 that illustrates the stages involved in gathering coverage data for a script by implementing a logger that receives events from the script runtime engine.

FIG. 13 is a process flow diagram for one implementation of the system of FIG. 1 that illustrates the stages involved in instrumenting a script for the purpose of gathering coverage data from its execution.

FIG. 14 is a diagram with an exemplary script before it has been instrumented by a code coverage process.

FIG. 15 is a diagram showing the script of FIG. 14 that has been that has been instrumented with additional properties to measure code coverage, with the additional properties being inserted on new lines.

FIG. 16 is a diagram showing the script of FIG. 14 that has been instrumented with additional properties to measure code coverage, with the additional properties being inserted so as not to disturb the existing line numbers.

FIG. 17 is a process flow diagram for one implementation of the system of FIG. 1 that illustrates the stages involved in measuring coverage data from multiple executions of the same script.

FIG. 18 is a process flow diagram for one implementation of the system of FIG. 1 that illustrates the stages involved in merging script coverage data from multiple executions of the script.

FIG. 19 is a process flow diagram for one implementation of the system of FIG. 1 that illustrates the stages involved in analyzing differences between multiple executions of the same script to isolate causes of behavioral differences.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as code coverage application for scripts, but the system also serves other purposes in addition to these. In one implementation, one or more of the techniques described herein can be implemented as features within any type of program that measures code coverage. In one implementation, the script code coverage application instruments one or more scripts with additional lines of code prior to execution that will allow the script execution engine to determine what lines were executed in the script(s). The coverage information can then be displayed to the user in a graphical user interface.

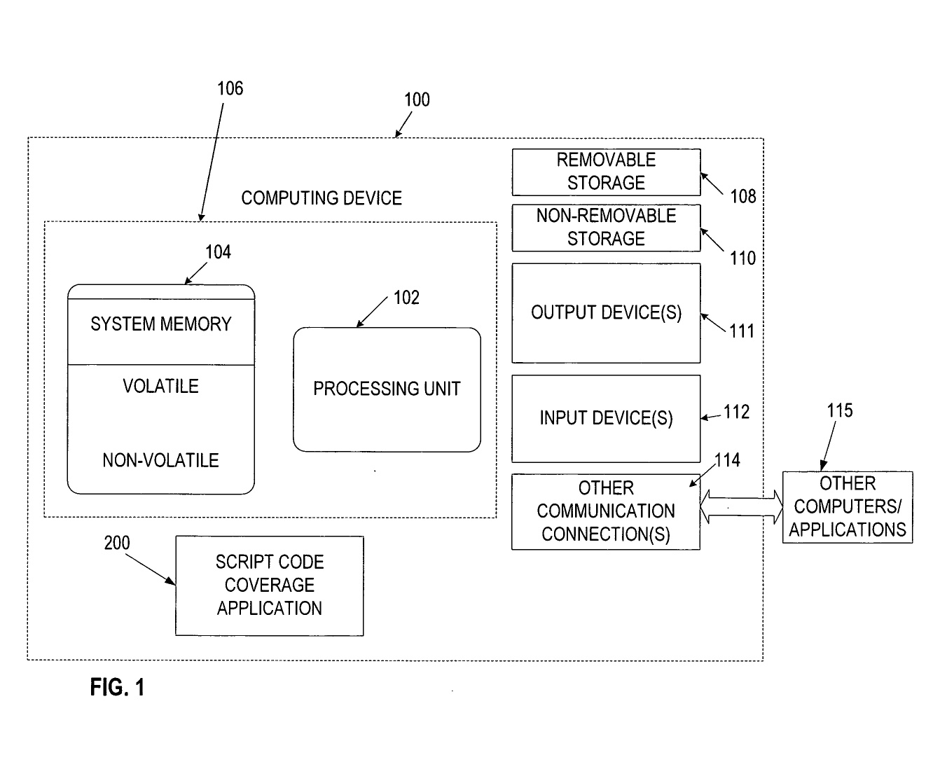

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

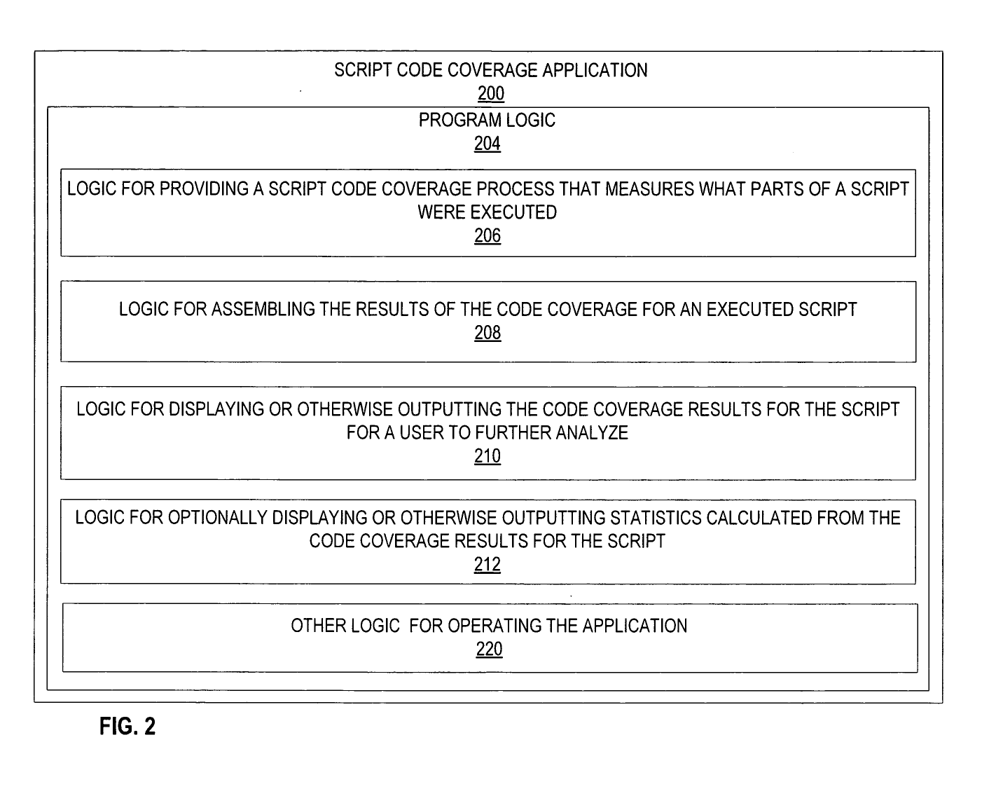

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes script code coverage application 200. Script code coverage application 200 will be described in further detail in FIG. 2.

Turning now to FIG. 2 with continued reference to FIG. 1, a script code coverage application 200 operating on computing device 100 is illustrated. Script code coverage application 200 is one of the application programs that reside on computing device 100. However, it will be understood that script code coverage application 200 can alternatively or additionally be embodied as computer-executable instructions on one or more computers and/or in different variations than shown on FIG. 1. Alternatively or additionally, one or more parts of script code coverage application 200 can be part of system memory 104, on other computers and/or applications 115, or other such variations as would occur to one in the computer software art.

Script code coverage application 200 includes program logic 204, which is responsible for carrying out some or all of the techniques described herein. Program logic 204 includes logic for providing a script code coverage process that measures what parts of a script were executed (after optionally instrumenting the script) 206; logic for assembling the results of the code coverage for an executed script 208; logic for displaying or otherwise outputting the code coverage results for the script for a user to further analyze 210; logic for optionally displaying or otherwise outputting statistics calculated from the code coverage results for the script 212; and other logic for operating the application 220. In one implementation, program logic 204 is operable to be called programmatically from another program, such as using a single call to a procedure in program logic 204.

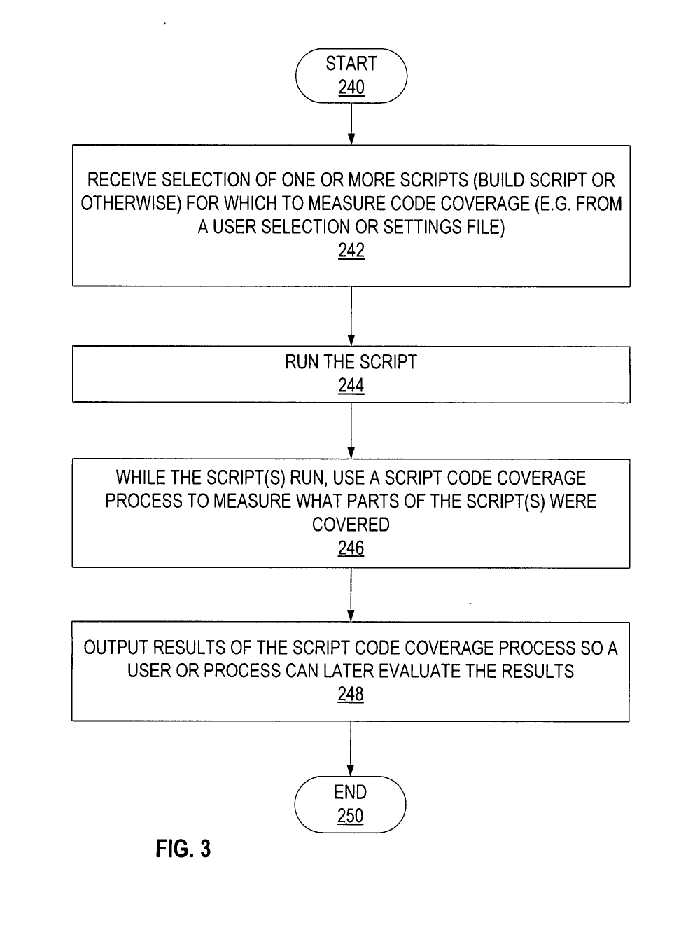

Turning now to FIGS. 3-19 with continued reference to FIGS. 1-2, the stages for implementing one or more implementations of script code coverage application 200 are described in further detail. FIG. 3 illustrates one implementation of the stages involved in measuring code coverage for a script. In one form, the process of FIG. 3 is at least partially implemented in the operating logic of computing device 100. The process begins at start point 240 with the system receiving a selection of one or more scripts for which to measure code coverage (e.g. from a user selection or settings file) (stage 242). In one implementation, the script is a build script. In other implementations, other types of scripts are used. The script(s) is/are executed by the script engine (stage 244), and while the script(s) is/are running, the system uses a script code coverage process to measure what parts of the script(s) were covered (stage 246). The system outputs the results of the script code coverage process so a user or process can later evaluate the results (stage 248). The process ends at end point 250.

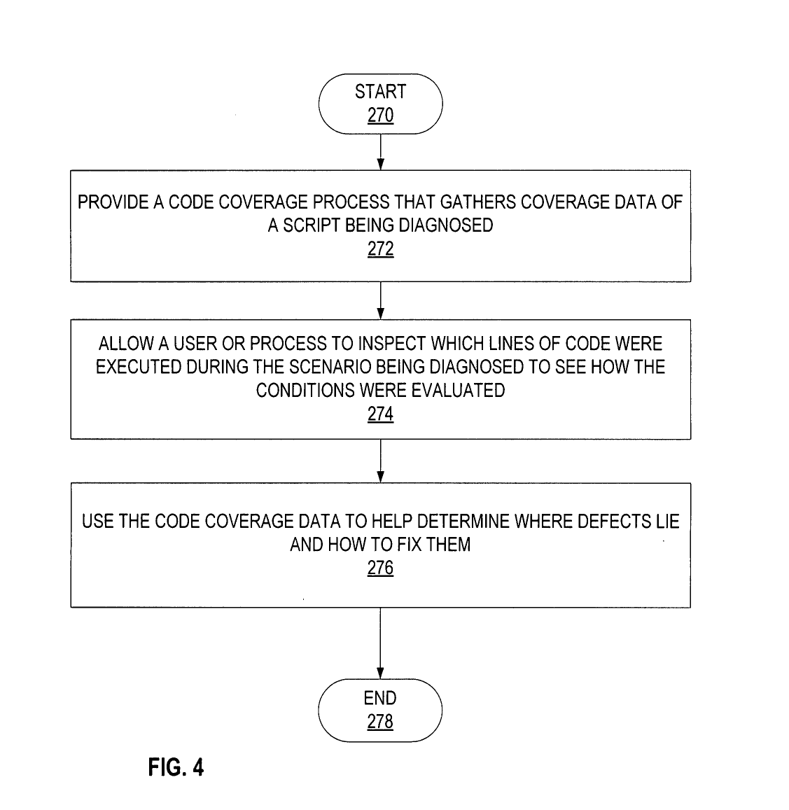

FIG. 4 illustrates one implementation of the stages involved in using code coverage to diagnose defects in a script. In one form, the process of FIG. 4 is at least partially implemented in the operating logic of computing device 100. The process begins at start point 270 with the system providing a code coverage process that gathers coverage data of a script being diagnosed (stage 272). The system allows a user or process to inspect which lines of code in the script were executed during the scenario being diagnosed to see how the conditions were evaluated (stage 274). The system uses the code coverage data to help determine where defects lie in the script and how to fix them (stage 276). The process ends at end point 280.

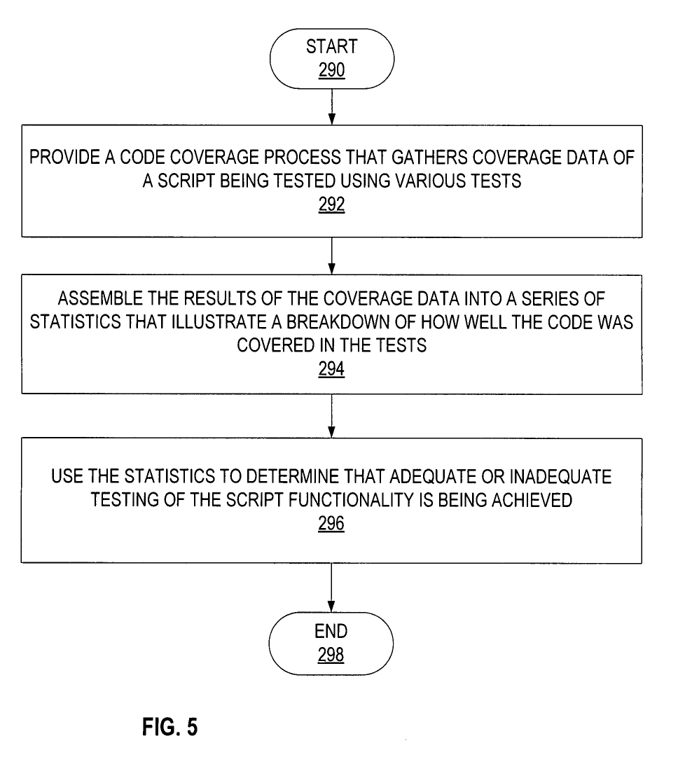

FIG. 5 illustrates one implementation of the stages involved in using code coverage to measure/analyze test coverage of a production script. In one form, the process of FIG. 5 is at least partially implemented in the operating logic of computing device 100. The process begins at start point 290 with the system providing a code coverage process that gathers coverage data of a script being tested using various tests (stage 292). The system assembles the results of the coverage data into a series of statistics that illustrate a breakdown of how well the code was covered in the tests (i.e. how much different parts were executed) (stage 294). The statistics are used to determine that adequate or inadequate testing of the script functionality is being achieved (stage 296). The process ends at end point 298.

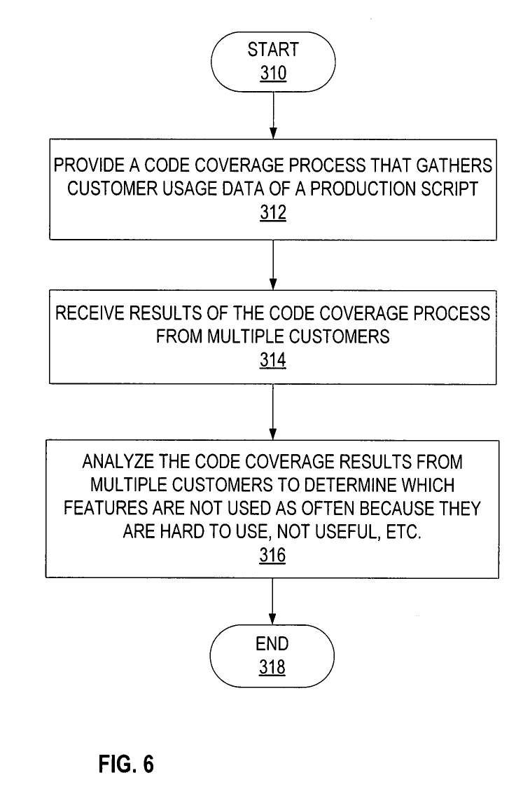

FIG. 6 illustrates one implementation of the stages involved in using code coverage to gather customer usage data of a production script. In one form, the process of FIG. 6 is at least partially implemented in the operating logic of computing device 100. The process begins at start point 310 with the system providing a code coverage process that gathers customer usage data of a production script (stage 312). The system receives the results of the code coverage process from multiple customers (stage 314). The code coverage results can be analyzed from multiple customers to determine which features are not used as often because they are hard to use, not useful, etc (stage 316). The process ends at end point 318.

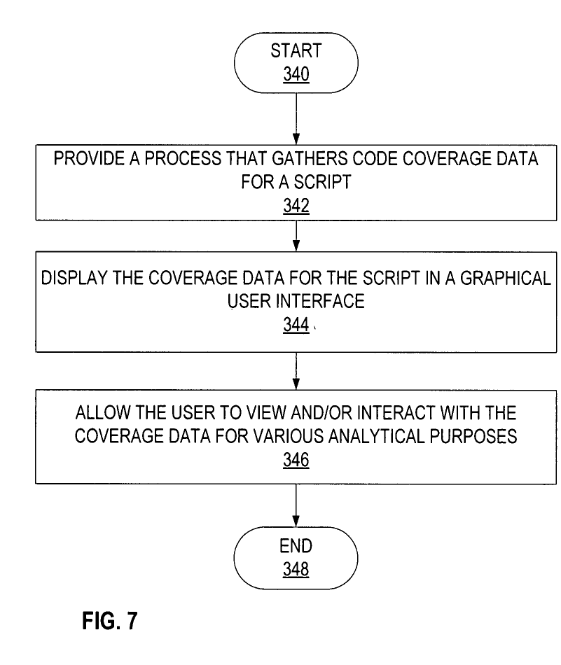

FIG. 7 illustrates one implementation of the stages involved in graphically displaying coverage data for a script. In one form, the process of FIG. 7 is at least partially implemented in the operating logic of computing device 100. The process begins at start point 340 with the system providing a process that gathers code coverage data for a script (stage 342). The system displays the coverage data for the script in a graphical user interface (stage 344). The user can view and/or interact with the coverage data for various analytical purposes (stage 346). The process ends at end point 348.

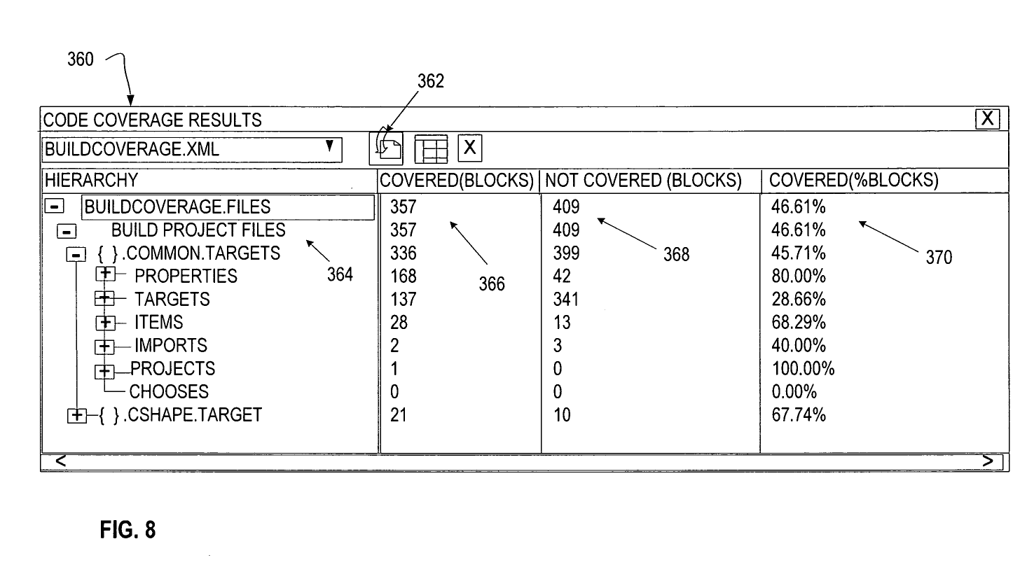

FIG. 8 is a simulated screen 360 for one implementation of the system of FIG. 1 that illustrates displaying code coverage results for a script. In the example shown, the particular script is a build script. The code coverage results of the build script were imported into the view upon selecting the open option 362. The particular items that were measured are shown in the hierarchy 364, and coverage information is shown in the corresponding columns. For example, the number of covered code blocks 366, the number of code blocks that were not covered 368, and the percentage of code blocks that were covered 370 are shown in the corresponding columns.

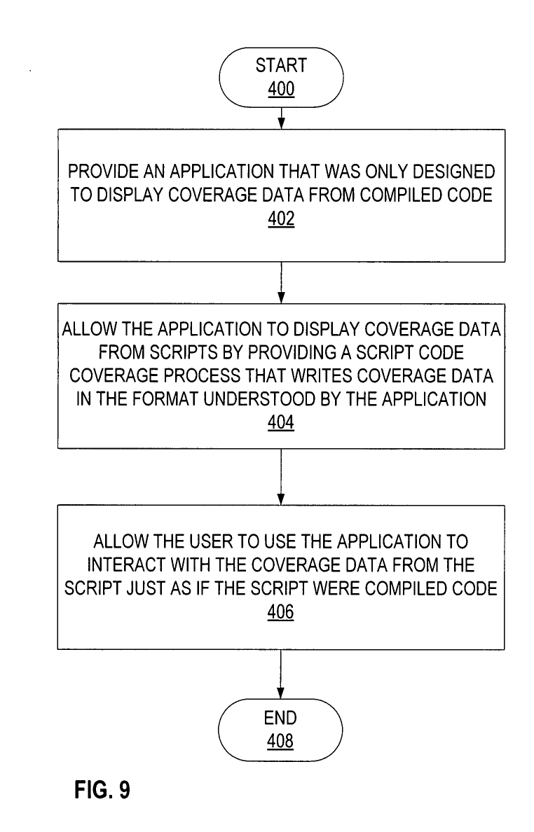

FIG. 9 illustrates one implementation of the stages involved in graphically displaying coverage data for a script in a system that was not designed to display code coverage for a script. In one form, the process of FIG. 9 is at least partially implemented in the operating logic of computing device 100. The process begins at start point 400 with providing an application that was only designed to display coverage data from compiled code (e.g. a development environment) (stage 402). The system allows the application to also display coverage data from scripts by providing a script code coverage process that writes coverage data in the coverage data format understood by the application (stage 404). The user is able to use the application to interact with the coverage data from the script just as if the script were compiled code (stage 406). The process ends at end point 408.

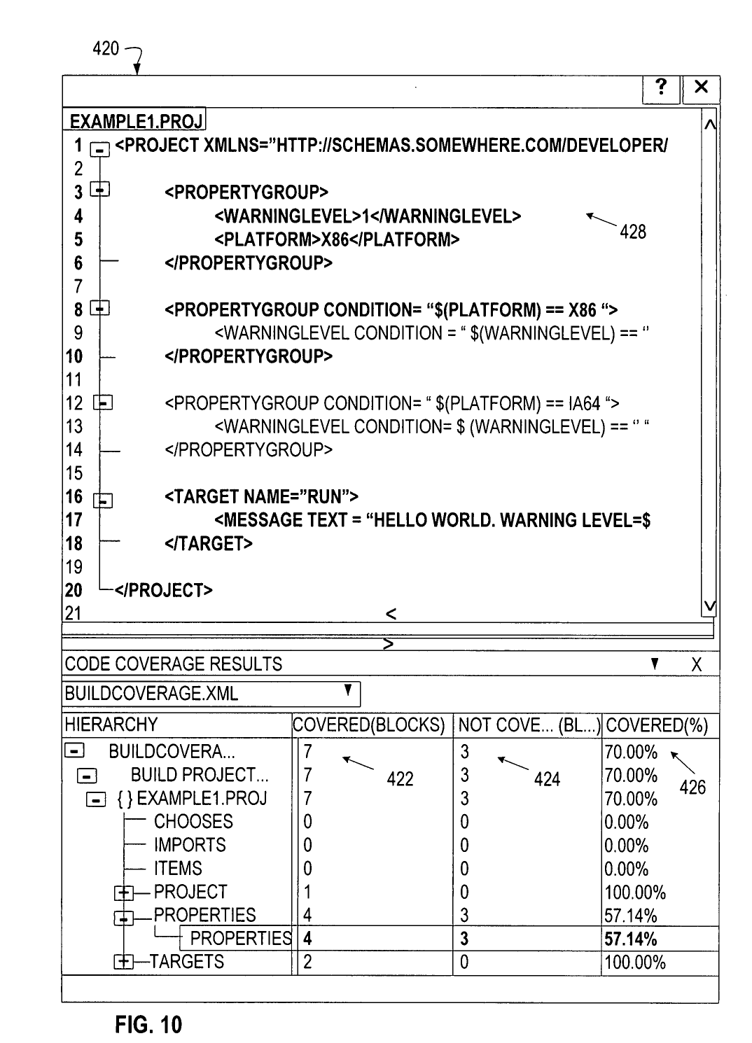

FIG. 10 shows a simulated screen 420 of a development environment of one implementation that displays code coverage of a script. In the example shown, the coverage information for the particular script is shown in the lower portion of the screen. The number of covered blocks 422, the number of uncovered blocks 424, and the percentage of covered blocks 426 are shown in corresponding columns. The source code for the script file 428 is displayed in the upper portion of the screen. A visual indicator is used to show which lines of code were executed in the particular part of the script being displayed on the screen. In the example shown, the lines of code in bold are the ones that were executed during the particular program execution that was measured by the code coverage process.

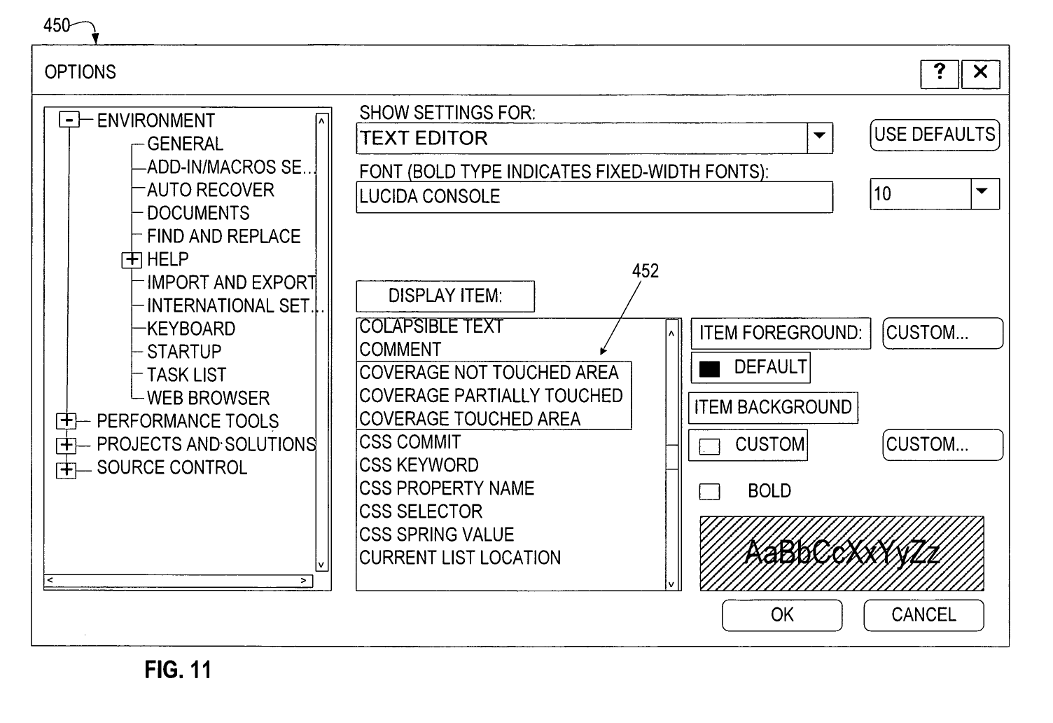

FIG. 11 shows a simulated screen 450 of a user settings dialog of a development environment that allows coverage data display settings 452 to be specified for a script. In the example shown, the user has selected an option to indicate color preferences for the code coverage that was not touched at all, that was partially touched, and that was touched.

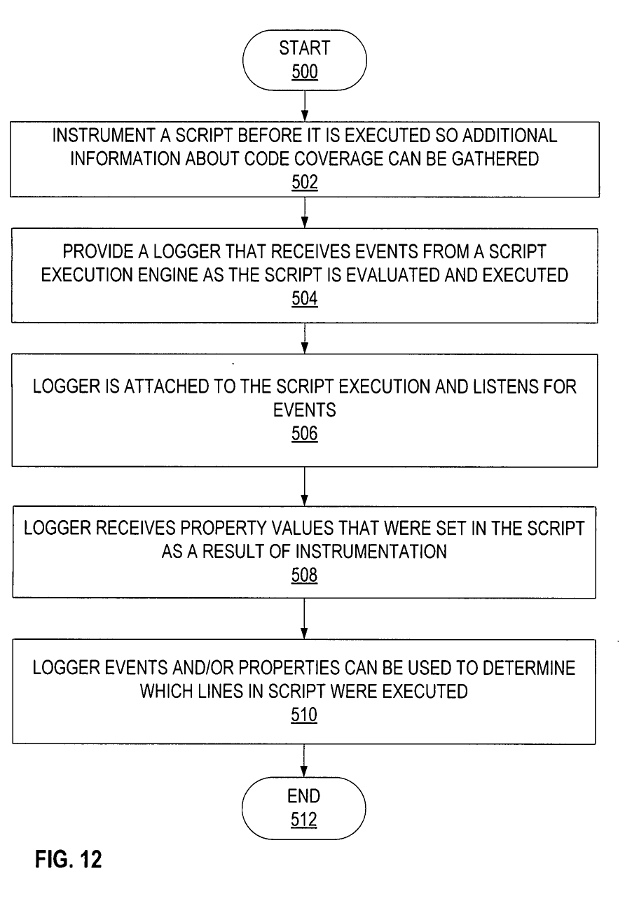

FIG. 12 illustrates one implementation of the stages involved in gathering coverage data for a script by implementing a logger that receives events from the script runtime engine. In one form, the process of FIG. 12 is at least partially implemented in the operating logic of computing device 100. The process begins at start point 500 with instrumenting a script before it is executed so additional information about code coverage can be gathered (stage 502). The system provides a logger that receives events from a script execution engine as the script is evaluated and executed (stage 504). The logger is attached to the script execution and listens for events (stage 506). The logger receives property values that were set as a result of the instrumentation in the script (stage 508). The logger events and/or properties can be used to determine which lines in the original uninstrumented script were executed and which were not (stage 510). The process ends at end point 512.

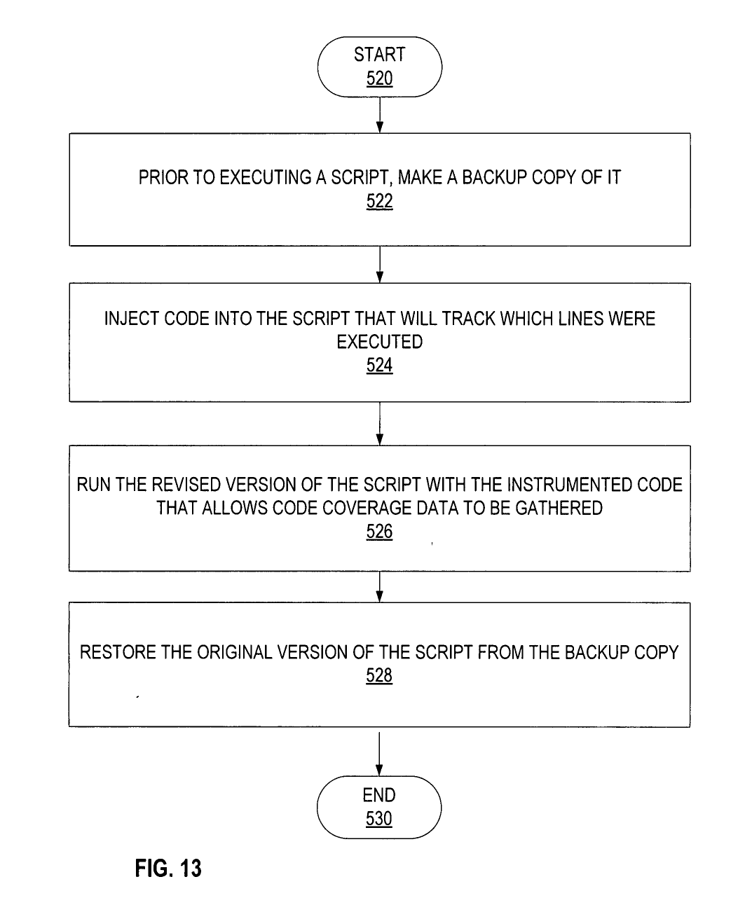

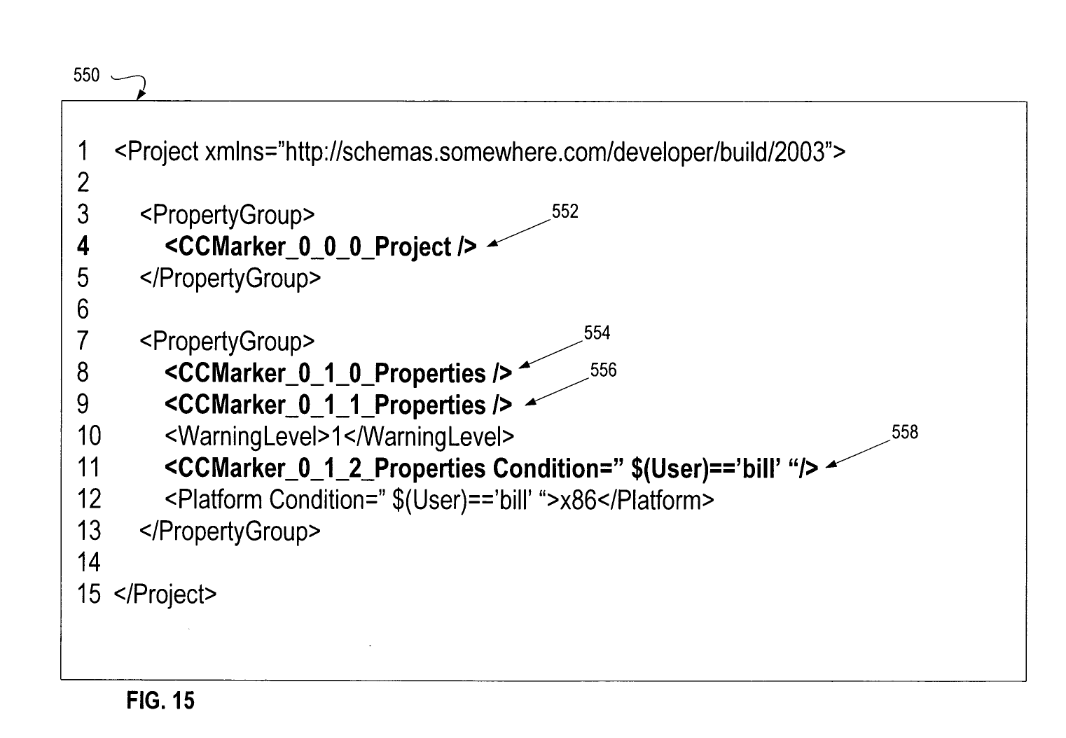

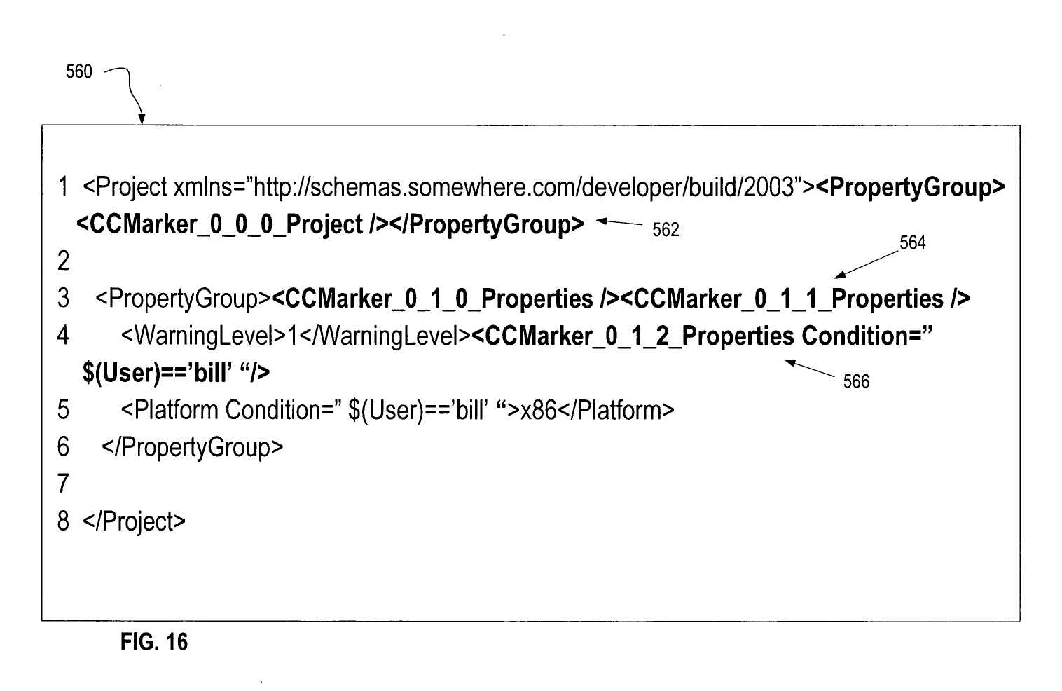

FIG. 13 illustrates one implementation of the stages involved in instrumenting a script for the purpose of gathering coverage data from its execution. In one form, the process of FIG. 13 is at least partially implemented in the operating logic of computing device 100. The process begins at start point 520 making a backup copy of a script prior to instrumenting it (stage 522). The system instruments (injects) code into the script that will track which lines were executed (stage 524). In one implementation, the line numbers in the original script are shifted after the instrumentation, as shown in further detail in FIG. 15. In another implementation, the line numbers in the original script are not shifted after the instrumentation, as shown in further detail in FIG. 16. The system runs the revised version of the script with the instrumented code that allows code coverage data to be gathered (stage 526). The system restores the original version of the script from the backup copy (so the end user does not see the altered version used for code coverage purposes) (stage 528). The process ends at end point 530.

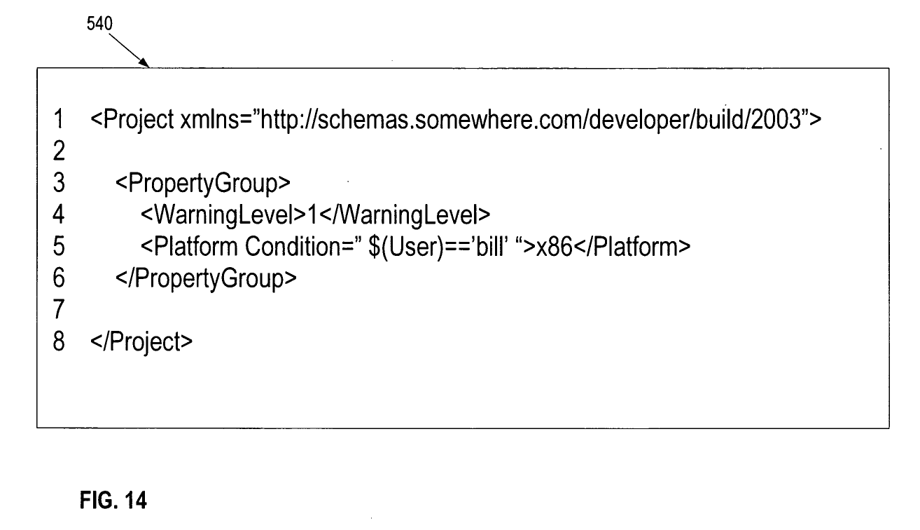

FIG. 14 is a diagram with an exemplary script 540 before it has been instrumented by a code coverage process. FIG. 15 is a diagram showing the script of FIG. 14 that has been that has been instrumented with additional properties to measure code coverage, with the additional properties being inserted on new lines. For example, new property markers (552, 554, 556, and 558, respectively) were inserted into existing property groups within the script to specify that those lines of code were reached in the script. Notice how by adding the new property markers, the line numbers of the original script have shifted by the additions. FIG. 16, on the other hand, is a diagram 560 that shows the same example as FIG. 15, but where the new property markers (562, 564, and 566, respectively) are inserted at the end of existing lines so that their insertion does not change the original line numbers.

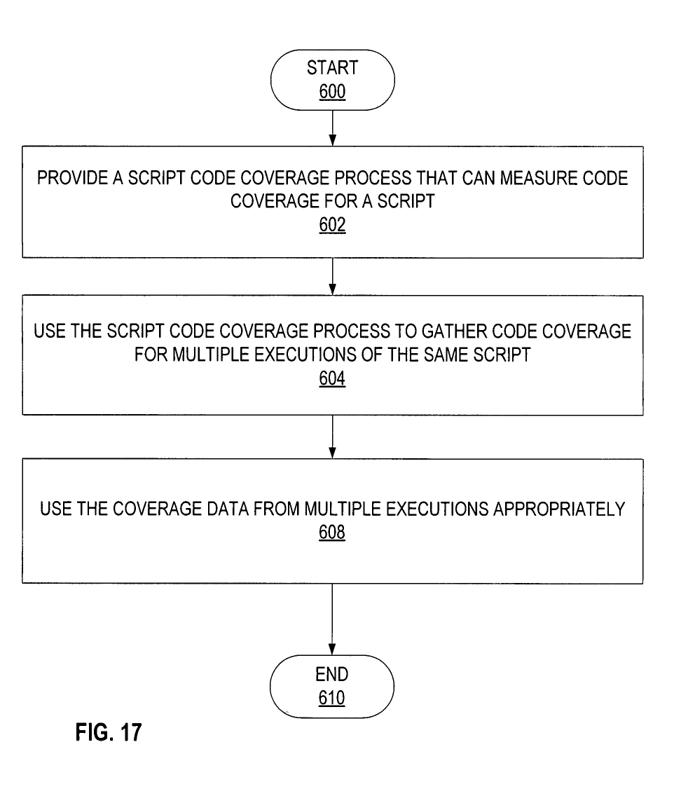

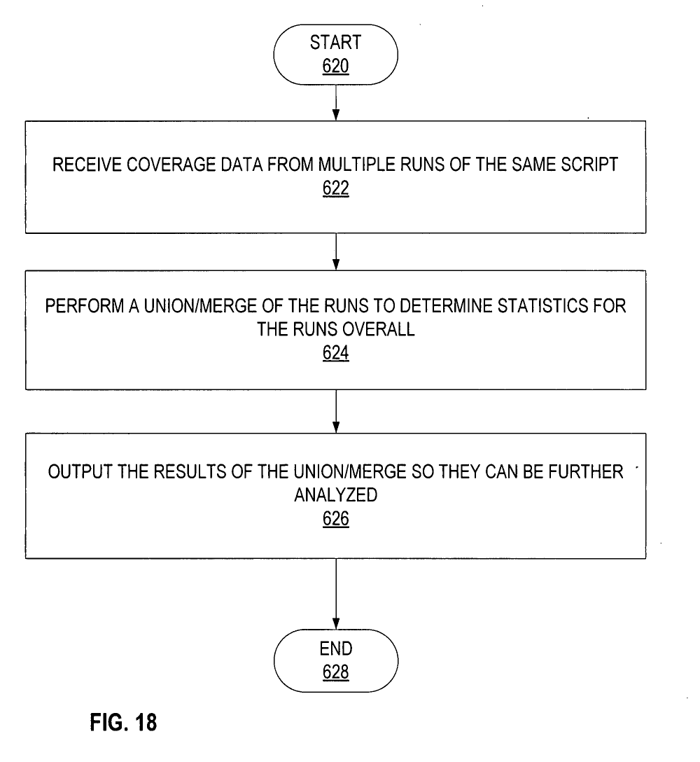

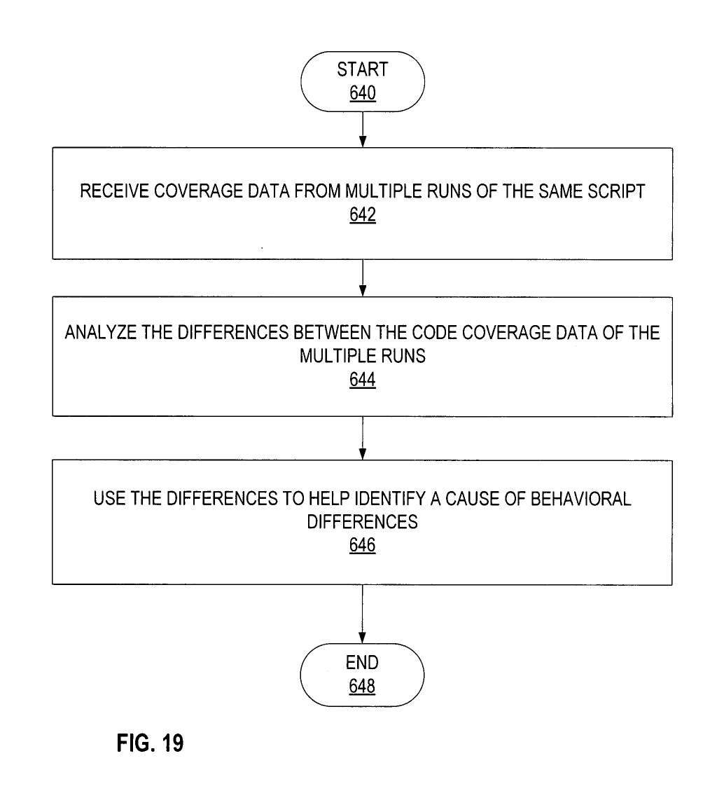

Turning now to FIG. 17, one implementation of the stages involved in measuring coverage data from multiple executions of the same script is described. In one form, the process of FIG. 17 is at least partially implemented in the operating logic of computing device 100. The process begins at start point 600 with the system providing a script code coverage process that can measure code coverage for a script (stage 602). The system uses the script code coverage process to gather code coverage for multiple executions of the same script (stage 604). The system uses the coverage data from multiple executions appropriately (stage 608), such as for the purposes described in further detail in FIGS. 18 and 19. The process ends at end point 610.

FIG. 18 illustrates one implementation of the stages involved in merging script coverage data from multiple executions of the script. In one form, the process of FIG. 18 is at least partially implemented in the operating logic of computing device 100. The process begins at start point 620 with the system receiving coverage data from multiple runs of the same script (stage 622). The system performs a union/merge of the runs to determine statistics for the runs overall (e.g. what % total of the code was run overall) (stage 624). The system outputs the results of the union/merge so they can be further analyzed (stage 626). The process ends at end point 628.

FIG. 19 illustrates one implementation of the stages involved in analyzing differences between multiple executions of the same script to isolate causes of behavioral differences. In one form, the process of FIG. 19 is at least partially implemented in the operating logic of computing device 100. The process begins at start point 640 with receiving coverage data from multiple runs of the same script (stage 642). The system analyzes the differences between the code coverage data of the multiple runs (stage 644). The identified differences can be used to help identify a cause of behavioral differences (stage 646). The process ends at end point 650.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A computer-readable medium having computer-executable instructions for causing a computer to perform steps comprising:
provide a code coverage process that measures the code coverage of a script while the script executes.

2. The computer-readable medium of claim 1, further having computer-executable instructions for causing a computer to perform the step comprising:
instrument the script prior to execution to insert commands that allow a code coverage of the script to be measured.

3. The computer-readable medium of claim 2, wherein the backup copy is restored after the execution of the script is finished.

4. The computer-readable medium of claim 1, further having computer-executable instructions for causing a computer to perform steps comprising:
output code coverage results from the measured code coverage of the script.

5. The computer-readable medium of claim 4, wherein the outputting stage is operable to display the code coverage results in a graphical format.

6. The computer-readable medium of claim 5, wherein the graphical format is operable to allow the user to interact with the code coverage results to obtain additional details.

7. The computer-readable medium of claim 4, wherein the outputting stage is operable to output the result in a log file.

8. The computer-readable medium of claim 1, wherein one or more statistics are calculated based on the measured code coverage.

9. The computer-readable medium of claim 1, wherein the code coverage process is used to measure coverage data for multiple executions of the script.

10. The computer-readable medium of claim 9, wherein the coverage data from multiple executions of the script are merged using a union to calculate a total percent of code that was run during the multiple executions.

11. The computer-readable medium of claim 9, wherein the coverage data from multiple executions of the script are analyzed to identify differences that may explain a cause of differences in behavior between the multiple executions of the script.

12. A method for measuring coverage data for a script comprising the steps of:
providing an instrumenting process that injects code into the script that will track which lines were executed;
running the script with the injected code that allows code coverage results to be gathered; and
outputting the code coverage results.

13. The method of claim 12, wherein the code coverage results are outputted for an analysis purpose selected from the group consisting of program defect analysis, adequacy of tests analysis, and customer feature usage analysis.

14. The method of claim 12, wherein one or more statistics are calculated based on the code coverage results.

15. The method of claim 14, wherein the statistics include a percentage of code that was covered during the execution of the script.

16. The method of claim 14, wherein the statistics include a number of lines of code that were covered during the execution of the script.

17. The method of claim 14, wherein the statistics include a number of lines of code that were not covered during the execution of the script.

18. A computer-readable medium having computer-executable instructions for causing a computer to perform the steps recited in claim 12.

19. A method for enabling a graphical tool that was only intended to display coverage data from compiled code to also display coverage data from a script comprising the steps of:
providing a code coverage application that was only designed to display coverage data gathered from executions of compiled code; and
allowing the code coverage application to also display coverage data from scripts by providing a script code coverage process that writes coverage data in a coverage data format understood by the code coverage application.

20. A computer-readable medium having computer-executable instructions for causing a computer to perform the steps recited in claim 19.
